(19) United States
(12) Patent Application Publication
(10) Pub. No.: US 2007/0106718 A1
(43) Pub. Date: May 10, 2007

(54) Fast fourier transform on a single-instruction-stream, multiple-data-stream processor

(76) Inventors: Hoi Leung Shum, Hong Kong (HK); Kwok Wah Law, Hong Kong (HK); Yiu Chung Poon, Hong Kong (HK)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/267,385

(22) Filed: Nov. 4, 2005

(51) Int. Cl. G06F 17/14

(52) U.S. Cl. 708/400

(57) ABSTRACT

A method of performing a fast Fourier transform (FFT) in a single-instruction-stream, multiple-data-stream (SIMD) processor includes providing n-bits of input data, and implementing j number of stages of operations. The n-bits of input data are grouped into groups of x-bits to form i number of vectors so that i=n/x. The method includes parallel butterflies operations on vector [i] with vector [i+(n/2)] using a twiddle factor vector Wₜ. Data sorting is performed within a processing array if a present stage j is less than y, where y is an integer less than a maximum value of j. The parallel butterflies operations and data sorting are repeated i times, then the process increments to the next stage j. The parallel butterflies operations, data sorting and incrementing are repeated (j−1) times to generate a transformed result and then the transformed result is output.

### BACKGROUND OF THE INVENTION

The present invention relates to a single-instruction-stream, multiple-data-stream (SIMD) processor, and more particularly, to an SIMD processor implementing a fast Fourier transform.

A fast Fourier transform (FFT) is an efficient algorithm to compute the discrete Fourier transform (DFT) and its inverse. The Cooley-Tukey algorithm is a common fast FFT algorithm. The Cooley-Tukey algorithm “re-expresses” the DFT of an arbitrary composite size n=n₁n₂ in terms of smaller DFTs of sizes n₁ and n₂, recursively, in order to reduce the computation time to O(n log n) for highly-composite n, where O is a mathematical notation used to describe an asymptotic upper bound for the magnitude of a function in terms of another simpler function. Because the Cooley-Tukey algorithm breaks the DFT into smaller DFTs, it can be combined arbitrarily with any other algorithm for the DFT. One use of the Cooley-Tukey algorithm is to divide the transform into two pieces of size n/2 at each step. The Cooley-Tukey algorithm recursively breaks down a DFT of any composite size n=n₁n₂ into many smaller DFTs of sizes n₁ and n₂, along with O(n) multiplications by complex roots of unity called “twiddle factors.” Twiddle factors are the coefficients used to combine results from a previous stage to form inputs to the next stage.

An SIMD processor uses a set of operations to efficiently handle large quantities of data in parallel. SIMD processors are sometimes referred to as vector processors or array processors because they handle the data in vectors or arrays. The difference between a vector unit and scalar units is that the vector unit handles multiple pieces of data simultaneously, in parallel with a single instruction. For example, a single instruction to add one 128-bit vector to another 128-bit vector results in up to 16 numbers being added simultaneously. Generally, SIMD processors handle data manipulation only and work in conjunction with general-purpose portions of a central processing unit (CPU) to handle the program instructions.

FIG. 1 shows the main portions of the architecture of a conventional SIMD processor 100. The SIMD processor 100 includes a column context memory 102, a row context memory 104 and a data buffer 106. The SIMD processor 100 also includes multiply-accumulate (MAC) blocks, logic and branching subunits (not shown). The column context memory 102 and row context memory 104 comprise static random access memory (SRAM), which are small and fast and do not need to be refreshed like dynamic RAM. Instructions are stored in the context memories 102 and 104 in column planes or row planes. For each cycle, instructions can be broadcast to cells RC 108 in row mode or column mode.

FIG. 2 is a block diagram demonstrating a conventional method of implementing a Cooley-Tukey FFT 110 on the SIMD processor 100. A 128-point FFT is demonstrated in which a data set x[0]-x[127] is input and a data set X[0]-X[127] is the resulting FFT output. Preliminarily, a bit reversal is performed by matrix transpose at block 112. The transposed data set x[0]-x[127] is moved through i stages of operations at block 114. Every stage i needs data sorting with stride equal to 2ⁱ⁻¹. Stride is the spacing of the components in a vector reference. For example, X(0:31) has a unit stride and Y(0:2:31) has stride two. The Cooley-Tukey FFT implementation depicted includes at least seven stages 1-7 of operations. While stages 1-3 are similar, stages 4-7 are different requiring irregular coding for stages 1-3 and 4-7. A transition buffer 116 is required for n>64. Implementing a Cooley-Tukey FFT scheme on the SIMD processor 100 requires a lot of intermediate data sorting, which consumes context memory and cycle counts. This is especially problematic for an SIMD processor with limited program memory.

FIG. 3 is a block diagram that illustrates an implementation of a 256-point FFT on another, conventional SIMD processor 120. The SIMD processor 120 performs odd/even sorting 122, an even 128-point FFT function 124, an odd 128-point FFT function 126, and a final (eighth) stage operation 128. A higher point FFT function can be built from the even and odd FFT functions 124 and 126 with the odd/even sorter 122, two lower point FFT kernels and the final (eighth) stage operation 128. This is the most effective implementation on the SIMD processor 120 using the Cooley-Tukey FFT, but unfortunately, it needs irregular coding for every other stage, and hence consumes more memory.

It would be desirable to provide an SIMD processor implementing an FFT. It would also be desirable to provide an SIMD processor implementing an FFT that uses parallel operations yet requires reduced memory consumption and complex intermediate data sorting.

### BRIEF DESCRIPTION OF THE SEVERAL VIEWS OF THE DRAWINGS

The following detailed description of preferred embodiments of the invention will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a block diagram of the major portions of a conventional single-instruction-stream, multiple-data-stream (SIMD) processor;

FIG. 2 is a block diagram demonstrating a conventional method of implementing a Cooley-Tukey FFT on an SIMD processor;

FIG. 3 is a block diagram demonstrating a conventional method of implementing a Cooley-Tukey FFT with n-bits from two FFT with n/2 bits each on an SIMD processor;

FIG. 4 is a block diagram demonstrating an implementation of an FFT on an SIMD processor in accordance with a preferred embodiment of the present invention;

FIG. 5 is a flow diagram showing the steps for performing the method of FIG. 4;

FIG. 6 is a block diagram of a twiddle factor look-up table in accordance with the preferred embodiment of the present invention;

FIGS. 7A-7C are block diagrams showing data sorting within an SIMD processor in accordance with the preferred embodiment of the present invention;

FIG. 8 is a table of results of memory usage of a 128-bit FFT and a 256-bit FFT in accordance with the preferred embodiment of the present invention compared to the conventional Cooley-Tukey FFT implementation; and

FIG. 9 is a block diagram depicting an exemplary parallel butterfly operation and data relabeling in accordance with the preferred embodiment of the present invention.

### DETAILED DESCRIPTION OF THE INVENTION

Certain terminology is used in the following description for convenience only and is not limiting. The word “a,” as used in the claims and in the corresponding portions of the specification means “at least one.”

Briefly stated, the present invention is a method of performing a FFT in a SIMD processor including providing n-bits of input data, where n is an integer value, and implementing j number of stages of operations, where j is an integer value. The n-bits of input data are grouped into groups of x-bits to form i number of vectors so that i=n/x, where i and x are integer values. The method includes performing parallel butterfly operations on vector [i] with vector [i+(n/2)] using a twiddle factor vector Wₜ retrieved from a twiddle factor vector look-up table. Data sorting is performed within a processing array if a present stage j is less than y, where y is an integer number less than a maximum value of j. The parallel butterfly operations and data sorting steps are repeated i times, then the process increments to the next stage j. The parallel butterflies operations, data sorting and incrementing steps are repeated (j−1) times to generate a transformed result, and then the transformed result is output.

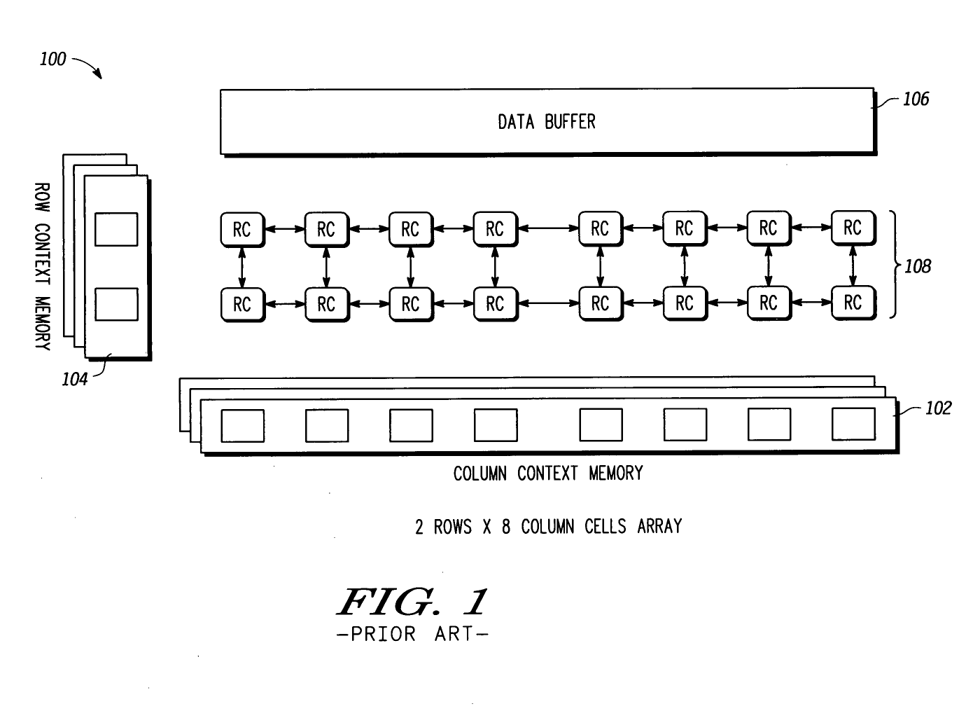

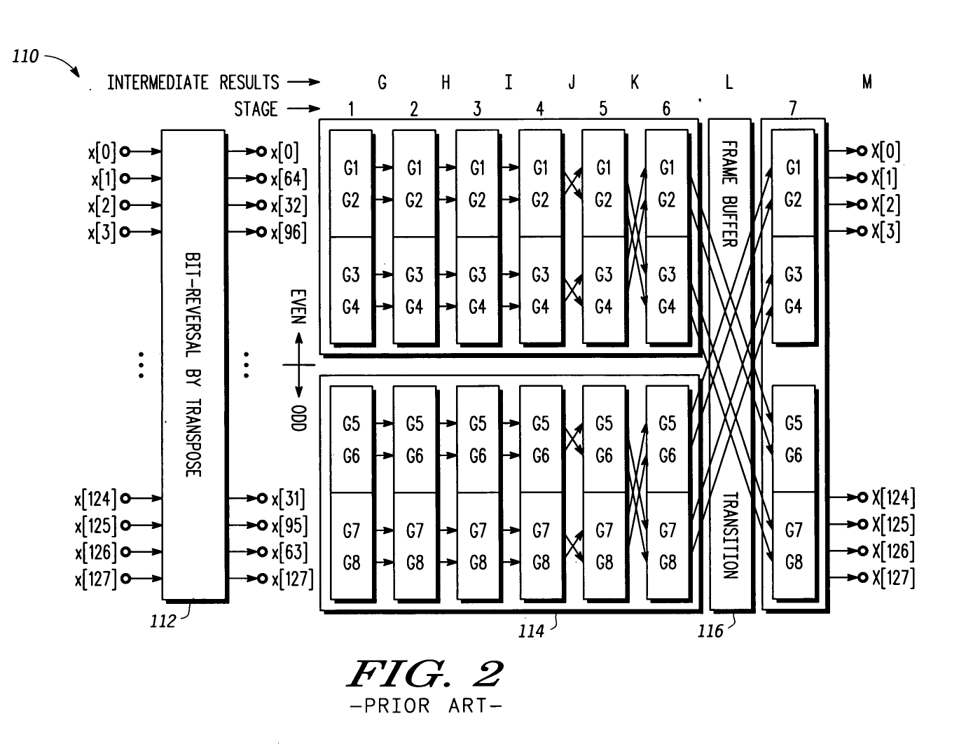

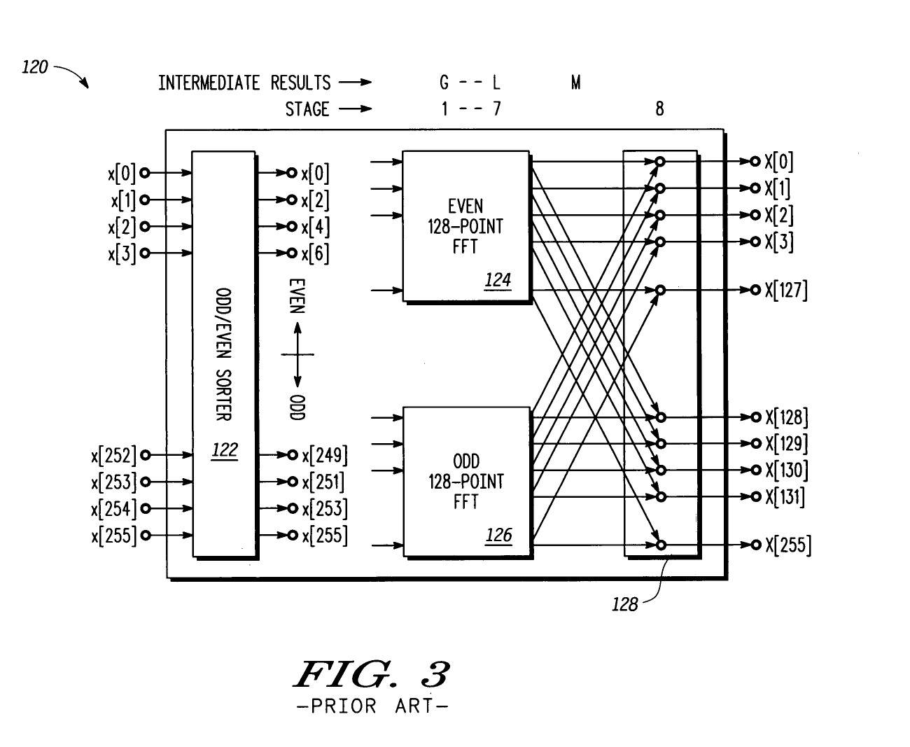

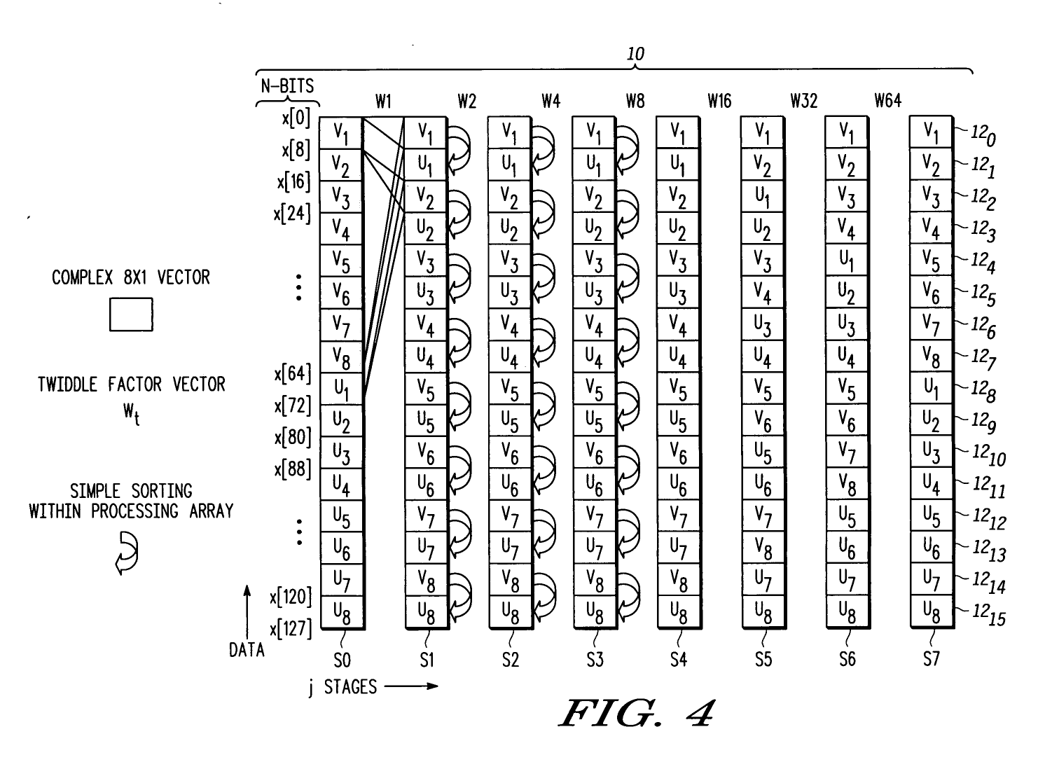

Referring to the drawings in detail, wherein like reference numerals indicate like elements throughout, there is shown in FIGS. 4-7 an implementation 10 of a FFT on a SIMD processor, such as the SIMD processor 100, in accordance with a preferred embodiment of the present invention. As previously discussed the SIMD processor 100 includes column and row context memories 102 and 104 (FIGS. 1-3). The SIMD processor 100 may be any type of SIMD or data array processor, as known by those of ordinary skill in the art.

FIG. 4 shows that there are j stages S0-S7 of operations performed by the SIMD processor 100 in accordance with the implementation 10. Each stage S0-S7 represents a data array processing unit comprised of cells 12₀-12₁₅ of x-bits of data.

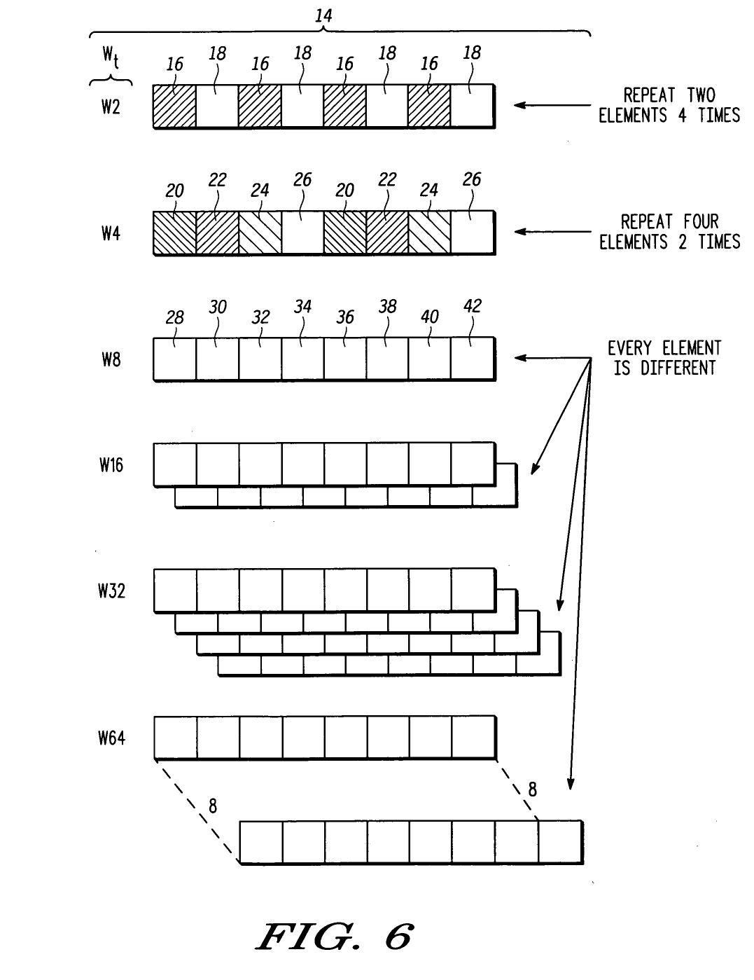

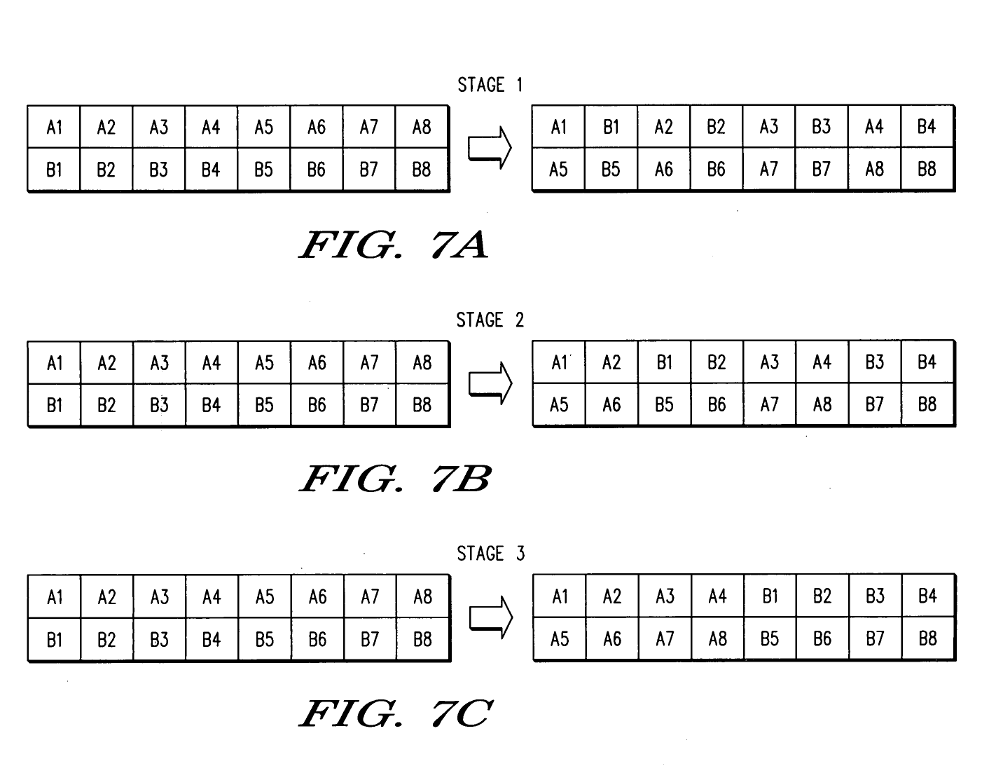

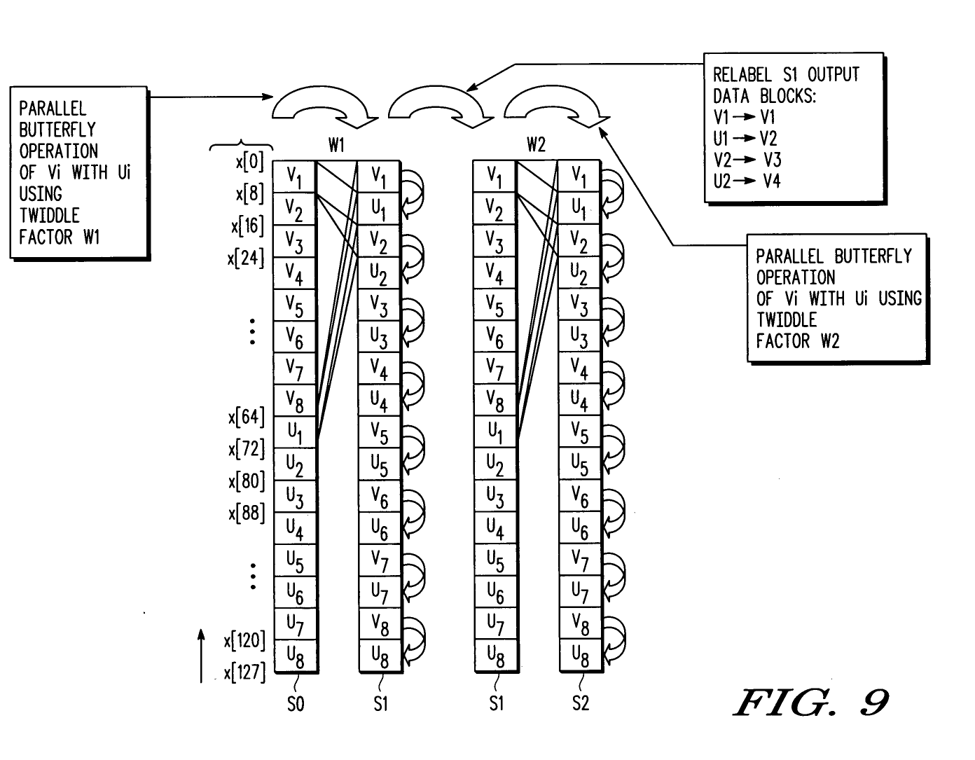

In particular, FIG. 4 shows an example of a 128-point FFT in which there are j stages S1-S7 of operations performed by the SIMD processor 100. 128-bits of data x[0] . . . x[127] are grouped into sixteen groups 12₀-12₁₅, where each group has 8-bits. For example, group 12₀ contains x[0]-x[7], group 12₂ contains x[8]-x[15], . . . , group 12₁₅ contains x[120]-x[127]. For a particular stage, say stage S1, group 12₆ and group 12₈ are loaded into the array processing unit and a parallel butterfly operation is performed with a twiddle factor W1 (FIG. 9), and then data sorting is performed inside the array processing units as shown in FIG. 7A. The results are written back to another data buffer. Then the process is repeated for group 12₁ with group 12₉, group 12₂ with group 12₁₀, group 12₃ with group 12₁₁, group 12₄ with group 12₁₂, group 12₅ with group 12₁₃, group 12₆ with group 12₁₄ and finally, group 12₇ with group 12₁₅. The corresponding results are written back on another data buffer. This is known as a “stage-wise parallel butterflies operation,” and the operation is carried out for all j stages. Each different stage S0-S7 has its own twiddle factor vector W1, W2, W4, W8, W16, W32, W64 generated as show in FIG. 6. For a different array matrix, the input data may be grouped differently, say 4, 8, 16, 32, 64 and so on.

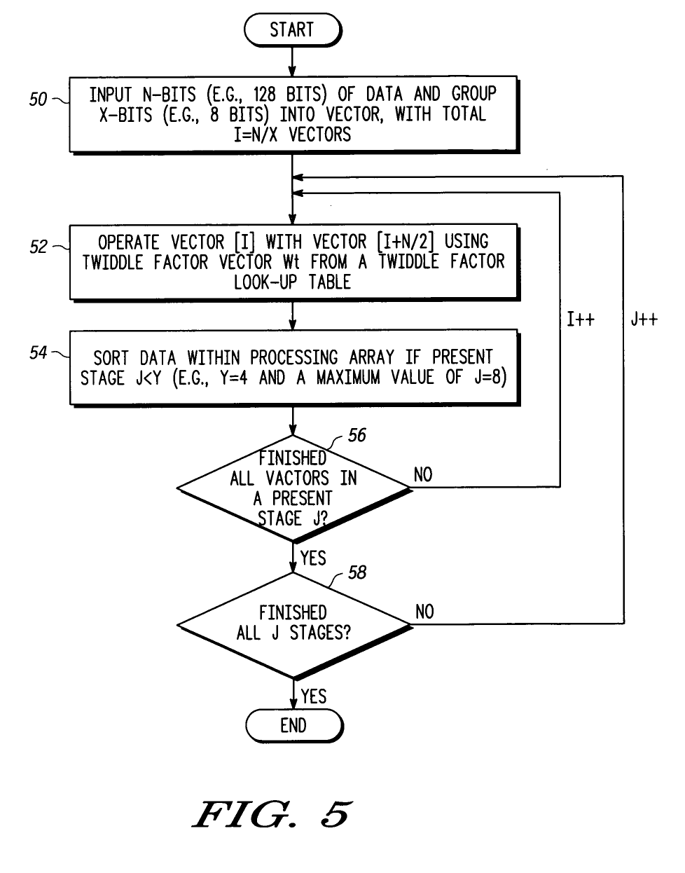

FIG. 5 is a flow diagram showing the steps for performing the method in accordance with the preferred embodiment of the present invention. A first step 50 shows that the method includes providing n-bits of input data, where n is an integer. For example, there may be 128-bits of input data x[0]-x[127]. The n-bits of input data are grouped into groups of x-bits to form i number of vectors such that i=n/x, where i and x are integers. For example, x may be 2, 4, 8, 16, 32, 128, 256, 512, 1024, 2048 and so on. Similarly, i may be 2, 4, 8, 16, 32, 128, 256, 512, 1024, 2048 and so on. Preferably, the data x[0]-x[127] in each of the i vectors is of unit stride. However, the data x[0]-x[127] in each of the i vectors can be radix 2, radix 4 or even mixed-radix data without departing from the present invention.

In a next step 52, parallel butterflies operations are performed on vector [i] with vector [i+(n/2)] using a twiddle factor vector Wₜ. The twiddle factor vector Wₜ may be retrieved from a twiddle factor look-up table. At step 54, data sorting is performed within a processing array if a present stage j is less than y, where y is an integer less than a maximum value of j, and j represents a number of stages of operations, where j is an integer. For example, there may be seven stages S1-S7, and y may be between one (1) and five (5). Preferably, y is four (4), so that the data sorting only occurs in the first three stages S1-S3. Step 56 checks whether or not all of the vectors in the present state j have been processed. More particularly, the parallel butterflies operation and data sorting are repeated i times, i.e., (i++), then the process increments to the next stage S1-S7, i.e., (j++). The parallel butterflies operations may include radix 2, radix 4, radix 7 or even mixed radix operators. Step 58 checks whether or not all of the stages S0-S7 have been processed. That is, the parallel butterflies operation, data sorting and incrementing are repeated (j−1) times so that all of the stages S0-S7 are processed, which generates a transformed result. The transformed result may then be output.

FIG. 6 shows a twiddle factor look-up table 14 in accordance with the preferred embodiment of the present invention. FIG. 6 shows that in twiddle factor vector W₂, two elements are repeated four times and, in twiddle factor vector W₄, four elements are repeated two times. The twiddle factor vectors W₈, W₁₆, W₃₂ and W₆₄ are based on the Stockham autosort algorithm. The twiddle factor look-up table 14 generally enables an FFT implementation on an SIMD processor by using the Stockham or transposed Stockham autosort algorithm or a variant thereof. The Stockham algorithm is derived by reorganizing the Cooley-Tukey procedure so that the intermediate DFTs are stored by row in natural order. In such a way, the bit-reversing computation required by the Cooley-Tukey process is avoided, but the sacrifice is workspace. The Stockham algorithm is one method to compute FFT in vector processing environments. The framework suggests a method of generating long length twiddle factors W1, W2, etc. In embodiments of the present invention, the twiddle factors W8, W16, W32, W64 are reused. Although W1, W2, W4 are used also, they are repeated and arranged differently in the twiddle factor lookup table 14 of the present invention.

The method discussed above with reference to FIG. 5 includes a butterfly or butterflies operation on vector [i] with vector [i+(n/2)] using a twiddle factor vector Wₜ that is retrieved from the twiddle-factor look-up table 14, where the twiddle factor look-up table 14 includes twiddle factor vectors W₁, W₂, W₄, W₈, W₁₆, W₃₂ and W_{n/2}. Table 1 below shows twiddle factor vector W1 for various size FFT functions. For example, for FFT128, the table should have twiddle factor vectors W1, W2, W4, W8, W16, W32, W64.

TABLE 1
Build Twiddle Factor Lookup Table: W1_long

FFT2 −> build W1_long = [W1]
FFT4 −> build W1_long = [W1 W2]
FFT8 −> build W1_long = [W1 W2 W4]
FFT16 −> build W1_long = [W1 W2 W4 W8]
FFT32 −> build W1_long = [W1 W2 W4 W8 W16]
FFT64 −> build W1_long = [W1 W2 W4 W8 W16 W32]
FFT128 −> build W1_long = [W1 W2 W4 W8 W16 W32 W64]
FFT256 −> build W1_long = [W1 W2 W4 W8 W16 W32 W64
W128]
FFT512 −> build W1_long = [W1 W2 W4 W8 W16 W32 W64
W128 W256]
FFT1024 −> build W1_long = [W1 W2 W4 W8 W16 W32 W64
W128 W256 W512]
FFT2048 −> build W1_long = [W1 W2 W4 W8 W16 W32 W64
W128 W256 W512 W1024]

The twiddle factor vector W1 contains one element, namely 1. But, it can be ignored during multiplication calculation and need not be put into the lookup table 14.

Twiddle factor vector W2 contains two elements calculated by the equation:
cos(2*pi*m/2ˆ2)−j*sin(2*pi*m/2ˆ2); for m=0 . . . 1
Twiddle factor vector W4 contains four elements calculated by the equation
cos(2*pi*m/2ˆ3)−j*sin(2*pi*m/2ˆ3); where m=0 . . . 3
Twiddle factor vector W8 contains eight elements calculated by the equation:
cos(2*pi*m/2ˆ4)−j*sin(2*pi*m/2ˆ4); where m=0 . . . 7
Twiddle factor vector W16 contains 16 elements calculated by the equation:
cos(2*pi*m/2ˆ5)−j*sin(2*pi*m/2ˆ5); where m=0 . . . 15
Twiddle factor vector W32 contains 32 elements calculated by the equation:
cos(2*pi*m/2ˆ6)−j*sin(2*pi*m/2ˆ6); where m=0 . . . 31
Twiddle factor vector W64 contains 64 elements calculated by the equation:
cos(2*pi*m/2ˆ7)−j*sin(2*pi*m/2ˆ7); where m=0 . . . 63

After the twiddle factors are generated, twiddle factor vector W2 is repeated four times and twiddle factor vector W4 is repeated two times. Twiddle factor vector W2 has only two twiddle factors 16, 18. To match them to the architecture of the SIMD machine to allow quick calculation, these two twiddle factors 16, 18 are repeated four times. Similarly, for twiddle factor vector W4, there are four different twiddle factors 20, 22, 24, 26 and they are repeated two times. In twiddle factor vector W8, there are eight different twiddle factors 28, 30, 32, 34, 36, 38, 40, 42 and they are not repeated at all. The number of repetitions is dependent on the architecture of the SIMD machine. Generally, if the SIMD processor has c columns of processing units, then in twiddle factor vector W₂, two elements are repeated c/2 times and, in twiddle factor vector W₄, four elements are repeated c/4 times. Similar repetition on twiddle factor vector Wₜ is necessary until c=t. Each of twiddle factor vectors W16, W32, W64 has all different twiddle factors (like 28, 30, 32, 34, 36, 38, 40, 42) which are not numbered here for simplicity. Finally, the twiddle factors are arranged to form a lookup table as shown in FIG. 6.

FIGS. 7A-7C are block diagrams depicting data sorting within an SIMD processor in accordance with the preferred embodiment of the present invention. As previously discussed, at step 54 (FIG. 5), data sorting is performed during or after the first three stages S1-S3. FIG. 7A shows the data sorting performed after the first stage S1, FIG. 7B shows the data sorting after the second stage S2 and FIG. 7C shows the data sorting after the third stage S3. Preferably, no further data sorting is required after the third stage S3. By implementing stage-wise vectorization and data sorting, code size and context memory can be minimized or at least reduced compared to conventional FFT algorithm implementations such as the Cooley-Tukey algorithm described with respect to FIGS. 1-3.

By way of explanation, the process of stepping through a few stages S0-S7 will be described. As shown in FIG. 4, each block V₁-V₈ and U₁-U₈ represents a different input complex vector V₁-V₈, U₁-U₈ of block size equal to eight that will be operating as a pair V₁-V₈ and U₁-U₈, respectively. The data in each of the blocks V₁-V₈ and U₁-U₈ may be different than its respective pairing V₁-V₈ and U₁-U₈. The blocks V₁-V₈ and U₁-U₈ merely represent the pairings of the groups 12₀-12₁₅ for performing operations and does not necessarily convey anything about the data within the groups 12₀-12₁₅.

FIGS. 7A-7C show a 128-point FFT calculation. The input vector has 128 complex bits or points x[0]-x[127] which are divided into sixteen groups 12₀-12₁₅, each group 12₀-12₁₅ has eight points. The sixteen groups 12₀-12₁₅ are grouped into two groups. The example shows that the two blocks will be operating as a pair with a twiddle factor vector W₁, W₂, W₄, W₈, W₁₆, W₃₂ . . . W_{n/2}.

For example, in stage S1, the twiddle factor vector W1 is unity. After the operation of the V1 and U1 blocks, they will form a block with size sixteen complex elements, arranged as two by eight array [2×8] in the SIMD machine, such as, A1-A8, B1-B8 as shown in FIG. 7A. These values are then sorted as shown in FIG. 7A before going to next stage S2. Then, the process is repeated on the V2 and U2 blocks, then the V3 and U3 blocks, and so on, until the V8 and U8 blocks. Now, stage S1 is completed.

Before starting the stage S2 operation, the stage S1 results are relabeled to be the same pattern as in stage S0 (FIG. 9). Thus, the process of operation in stage S2 will be same as that in stage S1 described above, but with a different twiddle factor vector W2, and with a different sorting method as shown in FIG. 7B. Similarly, the stage S3 results are generated by relabelling the stage S2 results, applying twiddle factor vector W3 and performing the sorting method in FIG. 7C. Stages S4-S7 operate in a similar fashion but no data sorting is necessary.

The preferred embodiment of the present invention results in savings of context memory and controller program memory as compared to conventional FFT algorithm implementations. The preferred embodiment of the present invention allows full utilization of the array processing units in every clock cycle. Furthermore, the preferred embodiment of the present invention has a regular pattern between stages permitting easier coding and code reuse.

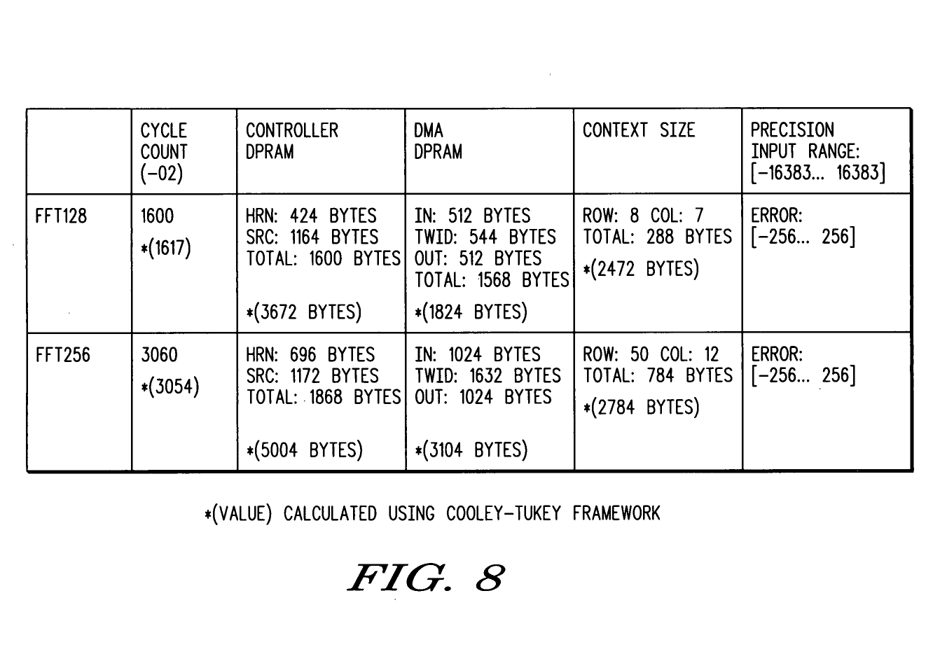

Experiments were performed using the FFT implementation in accordance with the preferred embodiment of the present invention. The experiments were performed using a MRC6011 processor, which is commercially available from Freescale Semiconductor, Inc. of Austin, Tex. The MRC6011 simulates an SIMD machine. The MRC6011 is able to run a fixed point simulator such as CodeWarrior RBC (i.e., reconfigurable compute fabric), which is also commercially available from Freescale Semiconductor, Inc. of Austin, Tex. Thus, the testing was performed using a SIMD machine-simulator running sample code based on the aforementioned description. Two FFT types were simulated including a 128-point FFT and a 256-point FFT. Both simulations were compared to a conventional Cooley-Tukey algorithm. FIG. 8 shows comparative results of memory usage of the 128-bit FFT in accordance with the preferred embodiment of the present invention compared to the conventional Cooley-Tukey FFT implementation. FIG. 8 also shows the memory usage of the 256-bit FFT implementation in accordance with the preferred embodiment of the present invention. The experimental results for the 128-point FFT demonstrate a 760% improvement in context memory utilization and a 130% improvement in controller memory utilization compared to the conventional Cooley-Tukey FFT implementation. The experimental results for the 256-point FFT demonstrated a 255% improvement in context memory utilization and a 168% improvement in controller memory utilization compared to the conventional Cooley-Tukey FFT implementation.

From the foregoing, it can be seen that the present invention is directed to a single-instruction-stream, multiple-data-stream (SIMD) processor, and more particularly, to an SIMD processor implementing a fast Fourier transform (FFT). It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of performing a fast Fourier transform (FFT) in a single-instruction-stream, multiple-data-stream (SIMD) processor, the method comprising:
providing n-bits of input data, where n is an integer value;
implementing j number of stages of operations, where j is an integer value;
grouping the n-bits of input data into groups of x-bits to form i number of vectors so that i=n/x, where i and x are integer values;
performing parallel butterflies operations on vector [i] with vector [i+(n/2)] using a twiddle factor vector Wₜ;
performing data sorting within a processing array if a present stage j is less than y, where y is an integer number less than a maximum value of j;
repeating the parallel butterflies operations and data sorting steps i times;
incrementing to the next stage j;
repeating the parallel butterflies operations, data sorting, repeating and incrementing (j−1) times to generate a transformed result; and
outputting the transformed result.

2. The method of performing a FFT according to claim 1, wherein the twiddle factor is retrieved from a twiddle factor look-up table and the look-up table includes twiddle factor vectors W₁, W₂, W₄, W₈, W₁₆, W₃₂ and W₆₄.

3. The method of performing a FFT according to claim 2, wherein the SIMD processor has c columns of processing units and, in twiddle factor vector W₂, two elements are repeated c/2 times and, in twiddle factor vector W₄, four elements are repeated c/4 times.

4. The method of performing a FFT according to claim 2, wherein the twiddle factor vectors W₈, W₁₆, W₃₂ and W₆₄ are based on the Stockham autosort algorithm.

5. The method of performing a FFT according to claim 1, wherein the data in each of the i vectors is of unit stride.

6. The method of performing a FFT according to claim 1, wherein x is one of 2, 4, 8, 16, 32, 128, 256, 512, 1024 and 2048.

7. The method of performing a FFT according to claim 1, wherein i is one of 2, 4, 8, 16, 32, 128, 256, 512, 1024 and 2048.

8. The method of performing a FFT according to claim 1, wherein y is between about 1 and 5.

9. The method of performing a FFT according to claim 1, wherein the parallel butterflies operations step includes one of radix 2, radix 4, radix 8 and mixed-radix operations.

10. A method of performing a fast Fourier transform (FFT) in a single-instruction-stream, multiple-data-stream (SIMD) processor, the method comprising:
providing 128-bits of input data;
implementing eight stages of operations;
grouping the 128-bits of input data into groups of 8-bits to form sixteen vectors;
performing parallel butterflies operations on vector [i] with vector [i+(n/2)] using a twiddle factor vector look-up table, the twiddle factor vector look-up table including vectors W₁, W₂, W₄, W₈, W₁₆, W₃₂ and W₆₄;
performing data sorting within a processing array if a present stage j is less than four;
repeating the parallel butterflies operations and data sorting step i times;
incrementing to the next stage j;
repeating the parallel butterflies operations, data sorting, repeating, and incrementing steps (j−1) times to generate a transformed result; and
outputting the transformed result.

11. The method of performing a FFT according to claim 10, wherein, in twiddle factor vector W₂, two elements are repeated four times and, in twiddle factor vector W₄, four elements are repeated two times.

12. The method of performing a FFT according to claim 10, wherein the twiddle vectors W₈, W₁₆, W₃₂ and W₆₄ are based on the Stockham autosort algorithm.
